(19) United States
(12) Patent Application Publication
(10) Pub. No.: US 2009/0176087 A1
(43) Pub. Date: Jul. 9, 2009

(54) Recording fabrics and manufacturing methods thereof

(75) Inventor: Chan-Oh Yoon, Cheongju-si (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/318,048

(22) Filed: Dec. 19, 2008

(30) Foreign Application Priority Data
Dec. 21, 2007 (KR) 10-2007-0135697

(51) Int. Cl. B32B 27/08; C08F 22/02; C08L 31/06; C08K 5/3475; C08K 3/22; C08K 3/26; C08K 3/34; B29C 67/00; B29D 7/00; B29C 47/00

(52) U.S. Cl. 428/337; 526/318.2; 428/483; 524/556; 524/105; 524/436; 524/425; 524/451; 428/339; 264/175; 264/212; 264/211.12

(57) ABSTRACT

The present invention relates to a recording fabric comprising a substrate layer, and an ink receiving layer formed on one or both surfaces of the substrate layer and containing glycol-modified polyethylene terephthalate, and a manufacturing method of the recording fabric. A recording fabric according to the present invention does not require an additional printing layer and is excellent in chemical properties, mechanical properties and flatness, thereby preventing a spreading or breaking phenomenon of the recording fabric from occurring when using the recording fabric. Furthermore, a recording fabric according to the present invention is characterized in that the recording fabric does not emit endocrine disruptor and harmful gases during use, incineration or fire.

### BACKGROUND ART

1. Technical field

The present invention relates to recording fabrics, and manufacturing methods thereof.

2. Description of the Related Art

A recoding fabric, in which synthetic resin sheets that function as recording layers are laminated on both surfaces of a fiber substrate by an adhesive, is generally used for advertisement or the like. At this time, as the synthetic resin sheets, sheets such as a polyolefin sheet or a polyvinyl chloride sheet are generally used.

However, although the polyolefin sheet is excellent in chemical resistance, it has shortcomings such as poor mechanical properties (ex. tensile strength and tear strength), adhesion properties and printability as compared with the polyvinyl chloride sheet. Although there are methods for treating surfaces of the sheets with corona and urethane to overcome the shortcomings, the methods are cumbersome and are not economical, since additional treatment using separate materials are needed.

Also, although the polyvinyl chloride sheet has relatively excellent mechanical properties, as compared to the polyolefin sheet, there is a problem in that toxic substances such as chlorine gas and endocrine disruptor are emitted during a incineration or a fire.

Korean Laid-open Patent Publication No. 2004-74228 discloses a fabric for printings using a polyolefin tarpaulin, in which polyolefins are formed on a polyolefin fiber by extrusion-coating, and then a printing layer is formed by coating polyurethane. However, the technique has problems in that the process is complicated and manufacturing costs are increased, since an additional polyurethane coating layer is formed to make the fabric.

Korean Patent No. 10-0316377 discloses a banner flex, which is manufactured by inserting a polyester fiber between two sheets of polyvinyl chloride sheets and then heating them, and a banner PET, in which a polyester film is adhered to the banner flex. However, the technique has a problem in that environmental friendliness is poor, since polyvinyl chloride is used as a substrate fiber.

Further, Japanese Laid-open Patent Publication No. 2001-113818 discloses a recording sheet in which an ink receiving layer comprising polyvinyl alcohol, polyvinylpyrrolidone, a cross-linking agent, a cation resin, and a polyvinyl alcohol-polyester copolymer is formed on a substrate. However, the technique also has a problem of increased manufacturing costs due to expensive materials constituting the ink receiving layer.

### SUMMARY

The present invention is conceived to solve the aforementioned problems in the prior art. An object of the present invention is to provide a recording fabric, which has excellent chemical and mechanical properties. Also, an object of the present invention is to provide a recoding fabric having excellent printability and flatness, which is environmental friendly and can be manufactured at a low cost, and a manufacturing method thereof.

According to one aspect of the present invention for achieving the object, there is provided a recording fabric comprising a substrate layer, and an ink receiving layer that is formed on one or both surfaces of the substrate layer and contains glycol-modified polyethylene terephthalate.

According to another aspect of the present invention, there is provided a manufacturing method of a recording fabric, which comprises the steps of manufacturing an ink receiving layer using a composition containing glycol-modified polyethylene terephthalate, and laminating the manufactured ink receiving layer on a substrate layer.

### BRIEF DESCRIPTION OF THE DRAWINGS

FIGS. 1 and 2 are sectional views of a recording fabric according to an embodiment of the present invention.

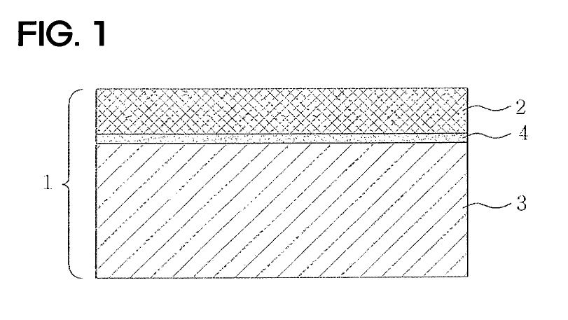

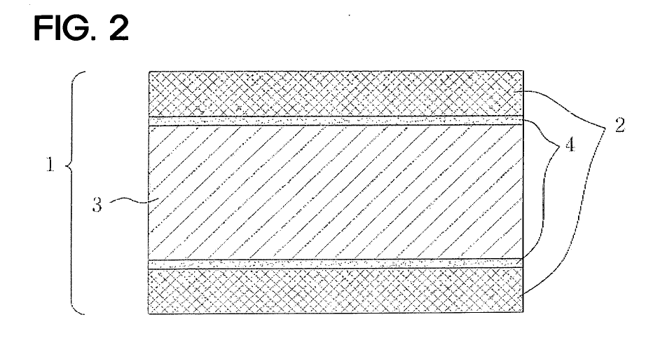

### DESCRIPTION OF THE PREFERRED EMBODIMENT

The present invention relates to a recording fabric, which comprises a substrate layer, and an ink receiving layer that is formed on one or both surfaces of the substrate layer and contains glycol-modified polyethylene terephthalate (hereinafter, referred to as “PET-G”).

Hereinafter, the recording fabric according to the present invention will be described in detail.

The recording fabric according to the present invention is characterized in that a substrate layer and a PET-G containing sheet layer are bonded to each other. Since the PET-G containing sheet layer functions as an ink receiving layer, the recording fabric does not require an additional printing layer, and exhibits excellent chemical properties, mechanical properties, flatness, and printability in a state where the PET-G containing sheet layer is bonded to the substrate layer.

Components constituting the substrate layer are not particularly limited in the present invention. For example, conventional fibers or films publicly known in the art can be used. Specific examples of the fibers or films include fibers or films composed of polyester resin, cellulose resin, polyamide resin, polyolefin resin, polystyrene resin, acryl resin, fluorine resin, or polycarbonate resin. Although it is preferable to use the polyester fibers or films among the above in economical aspects, the present invention is not limited thereto.

In the present invention, a substrate layer may have a thickness range, for example, from 25 μm to 500 μm. It is apprehended that tear strength of the fabric is lowered if the substrate layer has a thickness of less than 25 μm. Also, It is apprehended that flexibility of the fabric is deteriorated if the substrate layer has a thickness exceeding 500 μm.

The recording fabric according to the present invention comprises the sheet layer (ink receiving layer) which is formed on one or both surfaces of the aforementioned substrate layer, and contains PET-G. Here, the sheet layer can function as the ink receiving layer. In the present invention, specific types of PET-G that is a principal component included in the sheet layer are not particularly limited. For instance, an amorphous resin comprising terephthalic acid (TPA), ethylene glycol (EG), and cyclohexanedimethanol (CHDM) may be used as the PET-G. At this time, the PET-G may comprise 70 to 110 parts by weight of terephthalic acid, 20 to 90 parts by weight of ethylene glycol, and 10 to 80 parts by weight of cyclohexanedimethanol. Also, the PET-G may comprise 80 to 100 parts by weight of terephthalic acid, 30 to 80 parts by weight of ethylene glycol, and 20 to 70 parts by weight of cyclohexanedimethanol. Such PET-G has excellent workability, formability and printability, which are advantages of polyvinyl chloride (PVC), and the like, suppresses deformation due to contraction, is excellent in impact resistance, and does not emit harmful components such as chlorine gas and endocrine disruptor during incineration or fire.

The sheet layer included in the recording fabric according to the present invention may further comprise one or more components selected from the group consisting of a lubricant, an antioxidant, a UV absorbent, a fire retardant, a filler, a pigment, and an antistatic agent to improve various physical properties including printability, in addition to the aforementioned PET-G.

The lubricant can be added for improving workability of a resin composition containing the PET-G during manufacturing of the recording fabric. At this time, the lubricant may be contained in a content of 0.5 to 5 parts by weight, preferably 1 to 2 parts by weight, with respect to 100 parts by weight of the PET-G. It is apprehended that the resin composition is stuck to rolls and the like in a processing process if the content is less than 0.5 weight part while it is apprehended that printability of a product may be deteriorated if the content exceeds 5 parts by weight.

Types of the lubricants capable of being used in the present invention are not particularly limited. For examples, montan wax, esterified montan wax, olefin-based waxes, amide-based waxes, or a mixture of one or more thereof may be used as the lubricants.

The sheet layer according to the present invention may further comprise an antioxidant to improve resistance to heat or oxygen, workability under high temperature, and light resistance. The antioxidant may be contained in a content of 0.2 to 2 parts by weight, preferably 0.5 to 1 weight part, with respect to 100 parts by weight of the PET-G. It is apprehended that a yellowing phenomenon is generated, or the resin composition is stuck to rolls and the like in the processing process if the content is less than 0.2 weight part while workability of the resin composition may be deteriorated if the content exceeds 2 parts by weight.

Types of the antioxidants capable of being used in the present invention are not particularly limited. For examples, amine-based antioxidant, phenol-based antioxidant, phosphite-based antioxidant, or a mixture of one or more thereof may be used as the antioxidant.

The sheet layer included in the recording fabric according to the present invention may further comprise a UV absorbent to improve resistance to heat or oxygen, workability under high temperature, and light resistance. Here, the UV absorbent may be contained in a content of 0.2 to 2 parts by weight, preferably 0.5 to 1 weight part, with respect to 100 parts by weight of the PET-G. It is apprehended that effects to improve light resistance may be deteriorated if the content is less than 0.2 weight part while it is apprehended that workability can be lowered or colors of a product may be deteriorated if the content exceeds 2 parts by weight.

Types of the UV absorbents capable of being used in the present invention are not particularly limited. For examples, benzotriazole-based UV absorbent such as hydroxyphenyl benzotriazole, benzophenone-based UV absorbent such as hydroxybenzophenone, benzoate-based UV absorbent such as benzoate, cyanoacrylate-based UV absorbent such as cyanoacrylate, or a mixture of one or more thereof may be used as the UV absorbent.

The sheet layer according to the present invention may further comprise 5 to 20 parts by weight of a fire retardant with respect to 100 parts by weight of the PET-G to prevent the combustion of volatile organic compounds (VOCs) generated during printing. The fire retardant can be contained preferably in a content of 10 to 15 parts by weight with respect to 100 parts by weight of the PET-G. It is apprehended that effects to improve fire retardation may be deteriorated if the content is less than 5 parts by weight while it is apprehended that workability can be lowered if the content exceeds 20 parts by weight.

Types of the fire retardants capable of being used in the present invention are not particularly limited. For examples, antimony oxide (Sb₂O₃), aluminum hydroxide (Al(OH)₃), magnesium hydroxide (Mg(OH)₂), or a mixture of one or more thereof may be used as the fire retardants.

The sheet layer of the present invention may further comprise a filler for reinforcements and weight increasement. The filler may be contained in a content of 3 to 10 parts by weight, preferably 5 to 10 parts by weight, with respect to 100 parts by weight of the PET-G. It is apprehended that reinforcement may be deteriorated if the content is less than 3 parts by weight while it is apprehended that viscosity may be lowered or surface of a product may be roughened if the content exceeds 10 parts by weight.

Types of the fillers capable of being used in the present invention are not particularly limited. For examples, calcium carbonate (CaCO₃), magnesium carbonate (MgCO₃), talc, or a mixture of one or more thereof may be used as the fillers.

The sheet layer (ink receiving layer) of the recording fabric according to the present invention may further comprise 0.5 to 5 parts by weight of an antistatic agent with respect to 100 parts by weight of the PET-G to prevent static electricity that may be generated during printing. The antistatic agent may be contained preferably in a content of 0.5 to 1 weight part. It is apprehended that effects to improve antistatic properties may be deteriorated if the content is less than 0.5 weight part while it is apprehended that printability may be lowered if the content exceeds 5 parts by weight.

Types of the antistatic agents capable of being used in the present invention are not particularly limited. For examples, general anionic surfactant, nonionic surfactant, cationic surfactant, or a mixture of one or more thereof may be used as the antistatic agent.

The sheet layer (ink receiving layer) of the recording fabric according to the present invention may further comprise 5 to 20 parts by weight of a pigment with respect to 100 parts by weight of the PET-G to improve tinting strength and hiding power during printing. At this time, the pigment may be contained preferably in a content of 5 to 10 parts by weight. It is apprehended that effects to improve a tinting strength or hiding power may be deteriorated if the content is less than 5 parts by weight while it is apprehended that workability of the resin composition may be lowered if the content exceeds 20 parts by weight.

Types of the pigments capable of being used in the present invention are not particularly limited. For examples, general inorganic pigments such as titanium oxide may be used as the pigments.

A thickness of the sheet layer of the recording fabric according to the present invention comprising the foregoing components is not particularly limited, and may be selected properly according to application. For instance, the thickness of the sheet layer may be 10 to 1,000 μm, preferably 100 to 1,000 μm, more preferably 150 to 500 μm. It is apprehended that mechanical properties, such as tensile strength and tear strength, and printability may be deteriorated if the thickness of the sheet layer is less than 10 μm while it is apprehended that flexibility may be deteriorated if the thickness of the sheet layer exceeds 1,000 μm.

Furthermore, a method for attaching the foregoing sheet layer to a substrate layer is not particularly limited. For instance, the foregoing sheet layer can be adhered to the substrate layer using a means such as an adhesive. Types of adhesives capable of being used are not particularly limited. For example, one or more selected from the group consisting of melamine-based adhesives, epoxy-based adhesives, rubber-based adhesives, acryl-based adhesives, ester-based adhesives, and urethane-based adhesives, preferably ester-based adhesives, may be used as the adhesives. Furthermore, although it is desirable that the adhesives are two-parts type adhesives to prevent the reactivation at high temperature after processing, one-component type adhesives may also be used if the reactivation is suppressed at the high temperature.

Furthermore, the present invention relates to a manufacturing method of a recording fabric, which comprises the steps of manufacturing a sheet layer (ink receiving layer) using a composition containing glycol-modified polyethylene terephthalate, and attaching the sheet layer (ink receiving layer) to a substrate layer.

A method for manufacturing the sheet layer (ink receiving layer) is not particularly limited. For instance, the sheet layer (ink receiving layer) can be prepared by preparing a resin composition comprising PET-G as a principal component, and then forming the resin composition through a calendaring process, a casting process, or an extrusion process. In the calendaring process, mixing of the resin composition comprising PET-G as a principal component can be performed by a gelling process using a Banbury mixer. Also, in the case of gelling process using extrusion, a compound mixed with PET-G resin composition may be used.

A method for attaching the manufactured sheet layer to the substrate layer is not particularly limited. For instance, a method for laminating the sheet layer and the substrate layer after applying an adhesive to the sheet layer or the substrate layer may be used.

A method for manufacturing the substrate layer is also not particularly limited, and the substrate layer may be manufactured by a general process of the art using the foregoing resin.

The manufacturing method of the recording fabric according to the present invention is not limited to the foregoing methods. For instance, the recording fabric can be manufactured through a process of directly applying a resin composition comprising PET-G as a principal component to the substrate layer.

### EXAMPLES

Hereinafter, the present invention will be described in more detail through examples according to the present invention. However, the scope of the present invention is not limited to the following suggested examples.

### Example 1

A polyester-based fabric (1000 deniers, weft×warp=23×23) as a fiber substrate for manufacturing a recording fabric was prepared. Subsequently, 100 parts by weight (1 kg) of PET-G (Tsunami G S, Eastman Corporation, USA), 1 weight part (10 g) of Montan lubricant (WE-40, Clariant Corporation, USA), 0.5 weight part (5 g) of a phosphate-based antioxidant (Irganox B-561, Ciba-Geigy Corporation, Swiss), 0.5 weight part (5 g) of a UV absorbent (hydroxybenzotriazole), 10 parts by weight (100 g) of a fire retardant (antimony oxide), 5 parts by weight (50 g) of a filler (calcium carbonate) (H-calcium carbonate, LG Co. Ltd., Korea), 5 parts by weight (50 g) of a pigment (titanium oxide) (CR-834, Kerr McGee Chemical Corp., Australia), and 0.7 weight part (7 g) of an antistatic agent (nonionic surfactant) were mixed to prepare a composition for manufacturing a sheet layer. Then, after sufficiently gelling the prepared composition in a Banbury mixer, the gelled composition was injected into a calendar roll to manufacture a sheet layer with a thickness of 150 μm. Thereafter, a recording fabric was manufactured by laminating the polyester-based fiber and the manufactured sheet layer using an ester-based adhesive (ES-360, SK Chemical Corporation, Korea).

### Example 2

A recording fabric was manufactured by the same method as Example 1 except that a polyethylene terephthalate (PET) film (SH22, SKC Corporation, Korea) (of which both surfaces are treated with a primer) having a thickness of 350 μm was used as a substrate layer.

### Comparative Example 1

A recording fabric was manufactured by the same method as Example 1 except that a polyethylene sheet (LDPE, LG Chemical Co. Ltd., Korea) which does not contain PET-G was used as a sheet layer.

### Comparative Example 2

A recording fabric was manufactured by the same method as Example 1 except that a PVC (polyvinyl chloride) sheet which does not contain PET-G was used as a sheet layer.

### Test Examples

After measuring physical properties including printability and the like of the recording fabrics, which are manufactured in Examples and Comparative Examples, by general methods publicly known in the art, results of the measurement were recorded in the following Table 1.

TABLE 1

| | | | Comparative | Comparative |
|---|---|---|---|---|
| Items | Example 1 | Example 2 | Example 1 | Example 2 |
| Printability | Excellent | Excellent | Poor | Excellent |
| Tensile | 250 | 230 | 230 | 150 |
| strength | | | | |
| (kgf) | | | | |
| Tear strength | 100 | 80 | 80 | 70 |
| (kgf) | | | | |
| Thickness | ±20 | ±5 | ±30 | ±25 |
| deviation | | | | |
| (left, right ± μm) | | | | |

As seen from Table 1, Examples 1 and 2 exhibit superior flatness and excellent printability while maintaining excellent tensile and tear strengths. On the other hand, flatness and printability are poor while exhibiting superior mechanical strengths to some degree in case of Comparative Example 1 using the polyethylene film. In case of Comparative Example 2 using PVC, it can be seen that although somewhat superior flatness and printability are maintained, mechanical strengths such as tensile strength and tear strength are very poor, and it can be expected that a large amount of harmful substances such as chlorine gas and endocrine disruptor may be generated due to characteristics of the PVC material itself when using or disusing the PVC material.

A recording fabric according to the present invention is excellent in chemical and mechanical properties and exhibits excellent flatness and printability, thereby preventing a spreading or breaking phenomenon of the recording fabric from occurring in a process of using the recording fabric. Furthermore, a recording fabric according to the present invention has environmental friendly characteristics in that the recording fabric does not emit harmful gases such as chlorine gas and endocrine disruptor in a process of using the recording fabric or during incineration or fire.

What is claimed is:

1. A recording fabric, comprising:
a substrate layer; and
an ink receiving layer formed on one or both surfaces of the substrate layer and containing glycol-modified polyethylene terephthalate.

2. The recording fabric as claimed in claim 1, wherein the substrate layer is a synthetic resin fiber or a synthetic resin film.

3. The recording fabric as claimed in claim 2, wherein the synthetic resin comprises at least one selected from the group consisting of polyester resin, cellulose resin, polyamide resin, polyolefin resin, polystyrene resin, acryl resin, fluorine resin, and polycarbonate resin.

4. The recording fabric as claimed in claim 1, wherein the substrate layer has a thickness of 25 to 500 μm.

5. The recording fabric as claimed in claim 1, wherein the glycol-modified polyethylene terephthalate comprises terephthalic acid, ethylene glycol, and cyclohexanedimethanol.

6. The recording fabric as claimed in claim 1, wherein the ink receiving layer further comprises at least one selected from the group consisting of a lubricant, an antioxidant, a UV absorbent, a fire retardant, a filler, a pigment, and an antistatic agent.

7. The recording fabric as claimed in claim 6, wherein the lubricant comprises at least one selected from the group consisting of montan wax, esterified montan wax, olefin wax, and amide wax.

8. The recording fabric as claimed in claim 6, wherein the antioxidant comprises at least one selected from the group consisting of amine-based antioxidant, phenol-based antioxidant, and phosphate-based antioxidant.

9. The recording fabric as claimed in claim 6, wherein the UV absorbent comprises at least one selected from the group consisting of benzotriazole-based UV absorbent, benzophenone-based UV absorbent, benzoate-based UV absorbent, and cyanoacrylate-based UV absorbent.

10. The recording fabric as claimed in claim 6, wherein the fire retardant comprises at least one selected from the group consisting of antimony oxide, aluminum hydroxide, and magnesium hydroxide.

11. The recording fabric as claimed in claim 6, wherein the filler comprises at least one selected from the group consisting of calcium carbonate, magnesium carbonate, and talc.

12. The recording fabric as claimed in claim 6, wherein the antistatic agent comprises at least one selected from the group consisting of anionic surfactant, nonionic surfactant, and cationic surfactant.

13. The recording fabric as claimed in claim 1, wherein the ink receiving layer has a thickness of 10 to 1,000 μm.

14. The recording fabric as claimed in claim 1, further comprising a two-part type adhesive layer formed between the substrate layer and the ink receiving layer.

15. A manufacturing method of a recording fabric, comprising the steps of:
manufacturing an ink receiving layer using a composition containing glycol-modified polyethylene terephthalate; and
attaching the ink receiving layer to a substrate layer.

16. The manufacturing method as claimed in claim 15, wherein the ink receiving layer is manufactured by a calendaring process, a casting process, or an extrusion molding process.
